(19) United States
(12) Patent Application Publication
(10) Pub. No.: US 2014/0353443 A1
(43) Pub. Date: Dec. 4, 2014

(54) Load Bearing Structure for a Large-scale Vehicle

(71) Applicant: Sheng-Chien KUO, Changhua County (TW)

(72) Inventor: Sheng-Chien KUO, Changhua County (TW)

(21) Appl. No.: 13/904,549

(22) Filed: May 29, 2013

(51) Int. Cl. B62D 35/00

(52) U.S. Cl. CPC B62D 35/001
USPC 248/201

(57) ABSTRACT

A load bearing structure for a large-scale vehicle includes a base and a return unit. The base includes a mounting seat and a side-skirt connecting member which has a pivot portion pivoted to the mounting seat. The pivot portion includes a first contact portion, a second contact portion and a third contact portion, and under normal conditions, the first contact portion is abutted against the mounting seat. The return unit is located within the pivot portion and pivoted to the mounting seat to keep the side-skirt connecting member staying in the normal conditions. The third contact portion defines a second angle with respect to the top plate, which allows the side-skirt connecting member to pivot in a bidirectional manner when returning to its original position, so that collision between the mounting seat and the side-skirt connecting member can be prevented, and the fatigue problem is consequently solved.

### BACKGROUND OF THE INVENTION

1. Field of the Invention

The present invention relates to a load bearing structure for a large-scale vehicle, and more particularly to a side skirt carrying structure for a large-scale vehicle.

2. Description of the Prior Art

Airflow (drag) will be generated across and around the body of a vehicle in high-speed motion, and most of the vehicles are equipped with a spoiler to reduce the airflow. Besides, a large-scale vehicle normally has large tires and a relatively high body, and air will flow in from both sides of the body when the large-scale vehicle moves. Therefore, side skirts are very important to a large-scale vehicle. Side skirts are fixed at both sides of the body of the vehicle to reduce the airflow flowing under the body of the vehicle, reducing air drag and improving stability of the vehicle.

A conventional load bearing structure for carrying the side skirt of a large-scale vehicle is shown in FIGS. 1 and 2, and essentially comprises a mounting seat 10 and a side-skirt connecting member 11. The mounting seat 10 has a top plate 12 whose top surface is fixed to the lower edge of one side of a large-scale vehicle (not shown), within the mounting seat 10 are disposed torsion springs 13 which are arranged in pairs in such a manner that each of the torsion springs 13 has a fixed end 131 fixed to a hole 141 formed in a positioning surface 14 of the mounting seat 10. The side-skirt connecting member 11 is pivoted to the mounting seat 10 in such a manner that the side-skirt connecting member 11 is coupled to a mounting portion 15 and a side skirt (not shown). The side-skirt connecting member 11 has a push rod 16 abutted a movable end 132 of the torsion springs 13, and a rear abutting surface 17 of the side-skirt connecting member 11 is abutted against the positioning surface 14.

Under normal conditions, the abutting surface 17 of the side-skirt connecting member 11 keeps contacting the positioning surface 14, and the push rod 16 is abutted against the torsion springs 13. When the large-scale vehicle accelerates, the side-skirt connecting member 11 will pivot about the mounting seat 10 and toward the bottom of the large-scale vehicle, so that the abutting surface 17 will move away form the positioning surface 14, and the push rod 16 will compress the torsion springs 13. When the large-scale vehicle decelerates, the load bearing will be pushed back to normal conditions (back to its original position) by the torsion springs 13.

It is to be noted that whenever the load bearing structure returns back to normal, the abutting surface 17 will collide with the positioning surface, and as result, the mounting seat 10 and the side-skirt connecting member 11 will become fatigue or even break after repeated collision, causing potential danger.

The present invention has arisen to mitigate and/or obviate the afore-described disadvantages.

### SUMMARY OF THE INVENTION

The primary objective of the present invention is to provide a load bearing structure for a large-scale vehicle, which is capable of slowing down the speed that the load bearing structure returns to its original position, preventing collision between the mounting seat and the side-skirt connecting member.

To achieve the above objective, a load bearing structure for a large-scale vehicle in accordance with the present invention comprises a base and a return unit. The base includes a mounting seat and a side-skirt connecting member, the side-skirt connecting member has a pivot portion pivoted to the mounting seat, the pivot portion includes a first contact portion, a second contact portion and a third contact portion, and under normal conditions, the first contact portion is abutted against the mounting seat. The return unit is located within the pivot portion and pivoted to the mounting seat to keep the side-skirt connecting member staying in the normal conditions.

The present invention is characterized in that a third contact portion is formed on the pivot portion of the side-skirt connecting member and defines a second angle with respect to a first contact of the pivot portion, which allows the side-skirt connecting member to pivot in a bidirectional manner when returning to its original position, so that collision between the mounting seat and the side-skirt connecting member can be prevented, and the fatigue problem is consequently solved.

### BRIEF DESCRIPTION OF THE DRAWINGS

FIG. 1 is a side view of a conventional loading bearing structure for a large-scale vehicle;

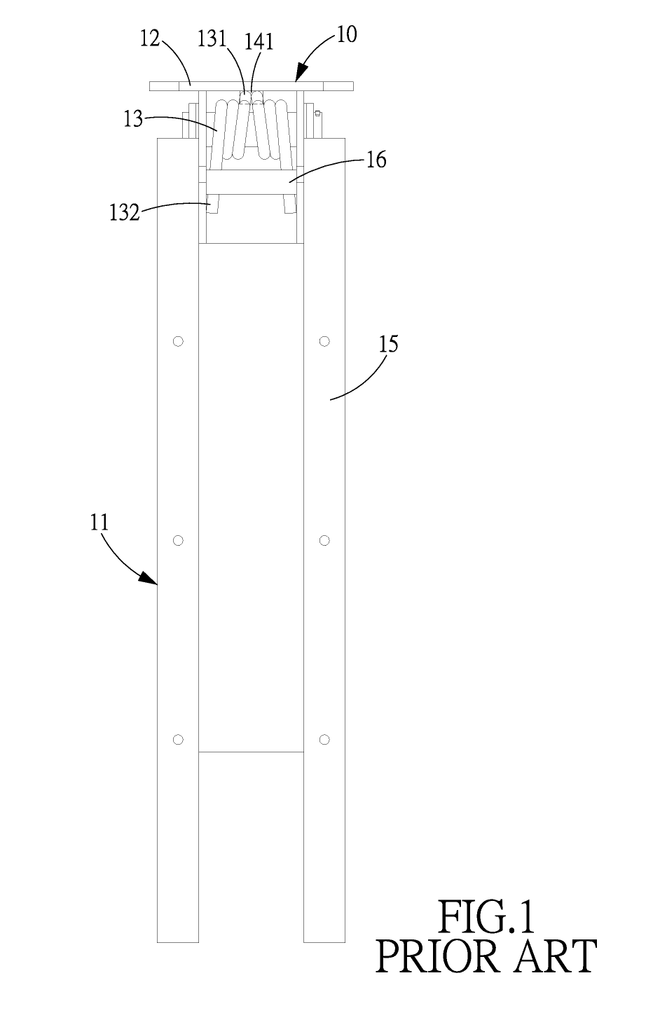

FIG. 2 is a cross sectional view of the conventional loading bearing structure for a large-scale vehicle;

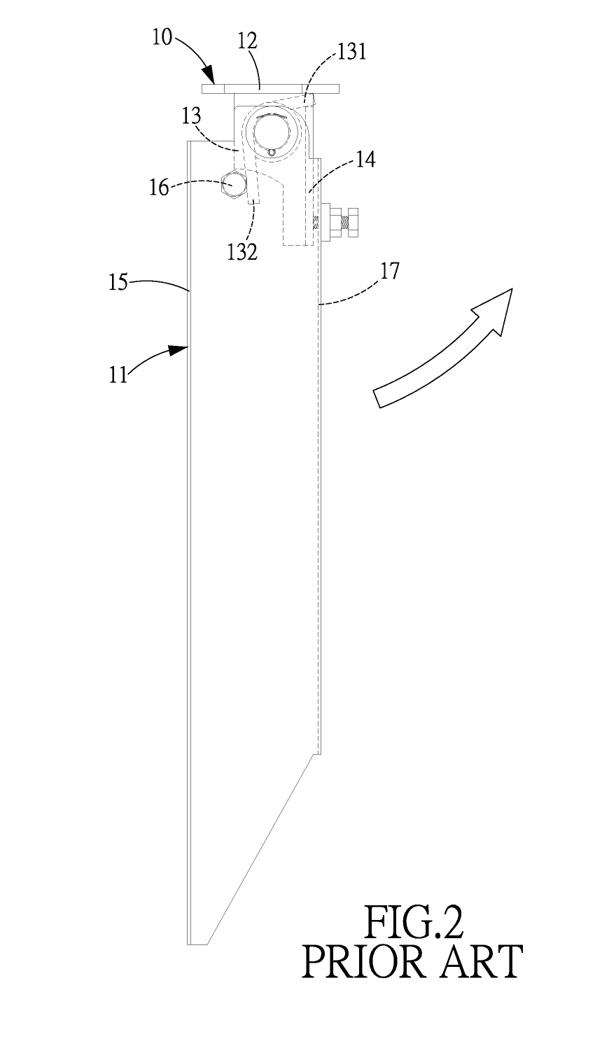

FIG. 3 is a perspective view of a load-bearing structure for a large-scale vehicle in accordance with the present invention;

FIG. 4 is an exploded view of the load bearing structure for a large-scale vehicle in accordance with the present invention;

FIG. 5 is a side view of the present invention showing the normal condition of the load bearing structure for a large-scale vehicle;

FIG. 6 is a cross sectional view of the present invention showing the normal condition of the load bearing structure for a large-scale vehicle;

FIG. 7 is a cross sectional view of the present invention showing that the side-skirt connecting member pivots toward the bottom of the large-scale vehicle;

FIG. 8 is a cross sectional view of the present invention showing that the side-skirt connecting member pivots away from the large-scale vehicle; and

FIG. 9 shows another embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

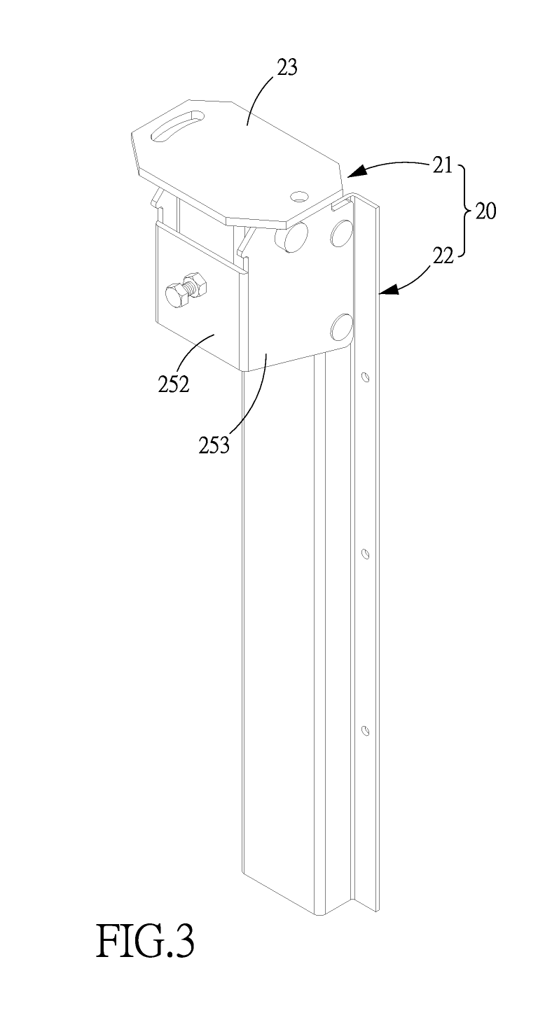

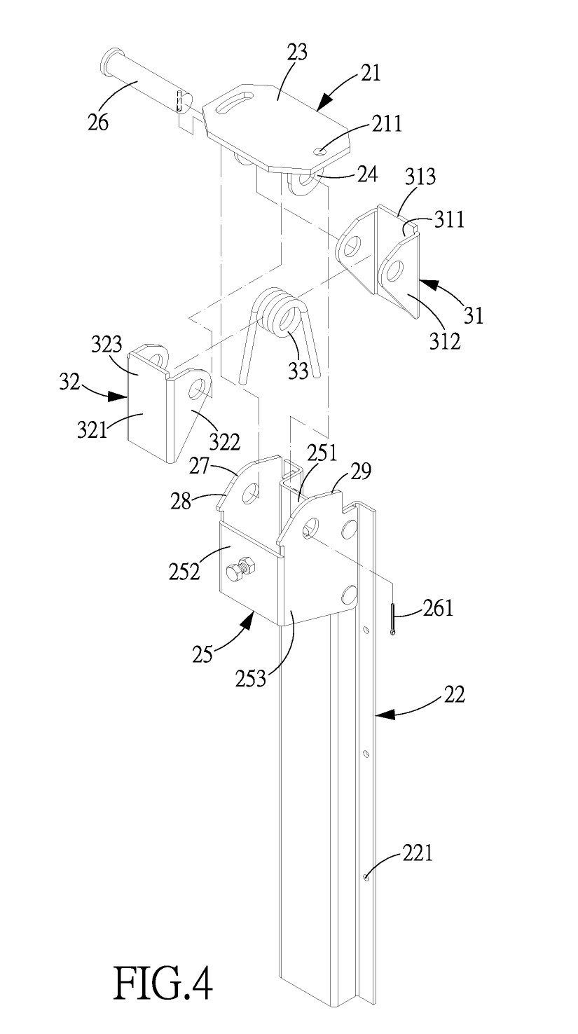

Referring to FIGS. 3-6, a load bearing structure for a large-scale vehicle in accordance with the present invention comprises: base 20 and a plurality of return units 30.

The base 20 includes a mounting seat 21 and a side-skirt connecting member 22. The mounting seat 21 is formed by a top plate 23 and a connecting portion 24 formed on a bottom of the top plate 23. The side-skirt connecting member 22 has a pivot portion 25 pivoted to the connecting portion 24 of the mounting seat 21. The pivot portion 25 is formed by an outer end surface 251, an opposite inner end surface 252, and two lateral plates 253. The pivot portion 25 is pivoted to the connecting portion 24 by a rod 26 inserted through the connecting portion 24 and the two lateral plates 253 of the pivot portion 25, and a pin 261 inserted in the rod 26. Each of the lateral plates 253 includes a first contact portion 27, a second contact portion 28 and a third contact portion 29 which are all located on the top of the pivot portion 25. The second contact portion 28 defines a first angle α ranging from 30-50 degrees with respect to the top plate 23 of the mounting seat 21, the third contact portion 29 defines a second angle β ranging from 10-20 degrees with respect to the top plate 23 of the mounting seat 21. In this embodiment, the first angle α is 40 degrees, and the second angle β is 15 degrees. Under normal conditions, the first contact portions 27 of the side-skirt connecting member 22 are abutted against the bottom of the top plate 23, the top plate 23 is formed with a fixing hole 211 allowing for the mounting seat 21 to be fixed to a lower edge of one side of the large-scale vehicle, and the side-skirt connecting member 22 is formed with a plurality of locking holes 221 so that the side-skirt connecting member 22 can be fixed to the side skirt of the large-scale vehicle.

The return units 30 are located among the outer end surface 251, the inner end surface 252 and the two lateral plates 253 of the pivot portion 25, and pivoted to the mounting seat 21 to keep the side-skirt connecting member 22 staying in the normal conditions where the first contact portions 27 of the side-skirt connecting member 22 are abutted against the bottom of the top plate 23. The return units 30 each include a first restricting member 31 with two first wings 312, a second restricting member 32 with two second wings 322, and an elastic member 33. The first restricting member 31 has a first abutting surface 311 abutted against the outer end surface 251 of the pivot portion 25, and the second restricting member 32 has a second abutting surface 321 abutted against the inner end surface 252 of the pivot portion 25. The first abutting surface 311 is formed with a first positioning rib 313 to push against the bottom of the top plate 23 of the mounting seat 21, and the second abutting surface 321 is also formed with a second positioning rib 323 to push against the bottom of the top plate 23 of the mounting seat 21. The elastic member 33 is a torsion spring biased between the first and second restricting members 31, 32, and the rod 26 is inserted in the first and second wings 312, 322 and the elastic member 33.

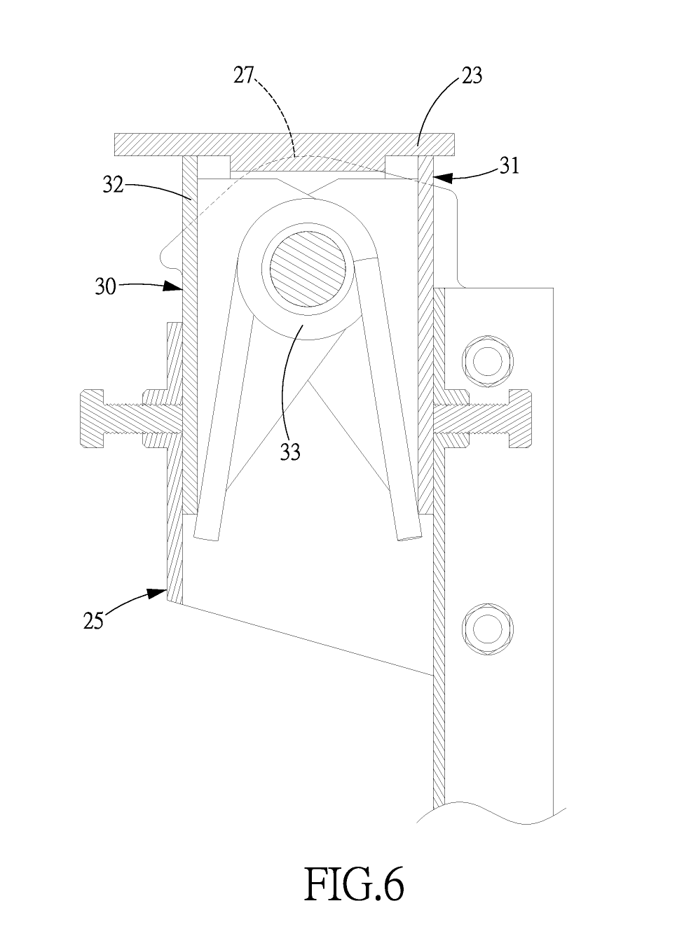

The abovementioned are the structural relationships of the main components of the load-bearing structure, and for a better understanding of the present invention, reference should be made to FIG. 6, wherein the elastic member 33 is biased between the first and second restricting members 31, 32, the first contact portions 27 of the pivot portion 25 are abutted against the bottom of the top plate 23, and under this circumstances, the elastic member 33 is in a released condition.

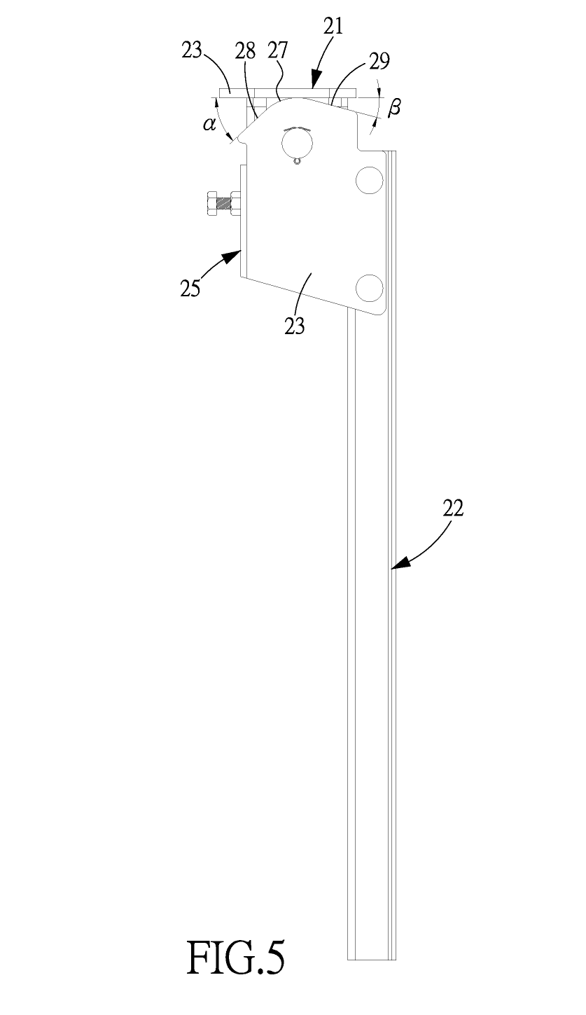

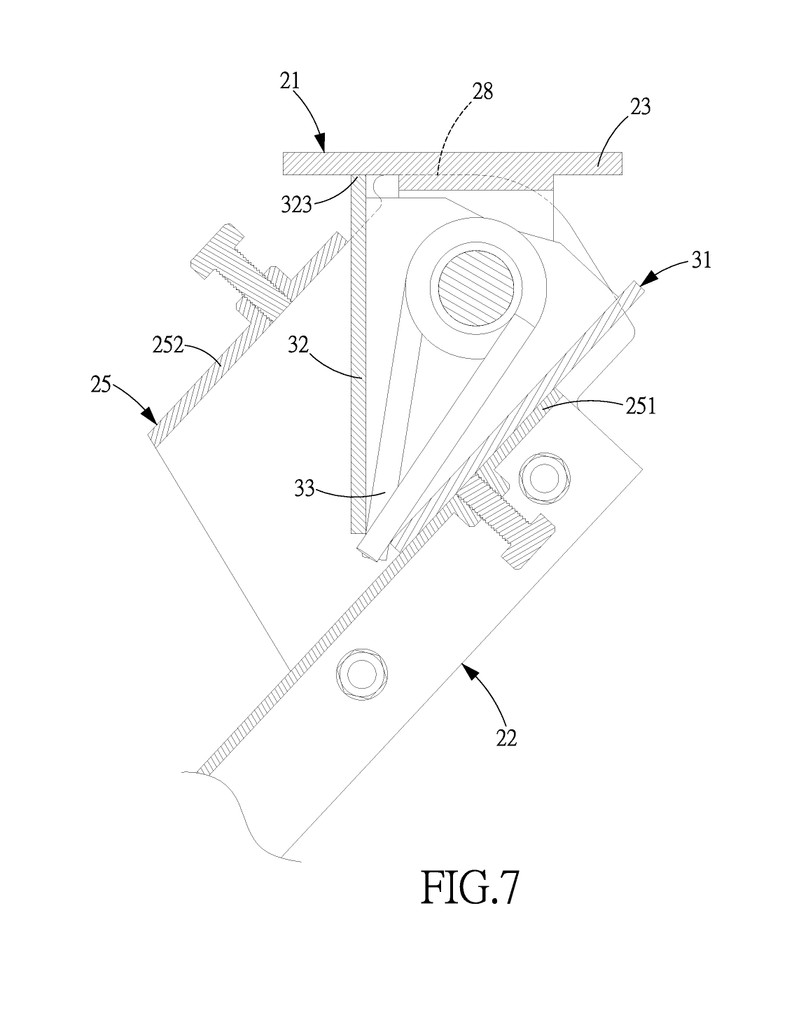

Referring then to FIGS. 7 and 5, when the side-skirt connecting member 22 pivots about the mounting seat 21 and toward the bottom of the large-scale vehicle, the first restricting member 31 will be pushed to pivot toward the second restricting member 32 by the outer end surface 251, while the second restricting member 32 stays stationary and is separated from the inner end surface 252 since it is stopped against the second positioning ribs 323. Meanwhile, the pivot portion 25 will use the second contact portions 28 to push against the bottom of the top plate 23. At this moment, the elastic member 33 is compressed due the distance between the first and second restricting members 31, 32 shrinks. Furthermore, the maximum angle that the side-skirt connecting member 22 is allowed to pivot toward the bottom of the large-scale vehicle is equal to the first angle α.

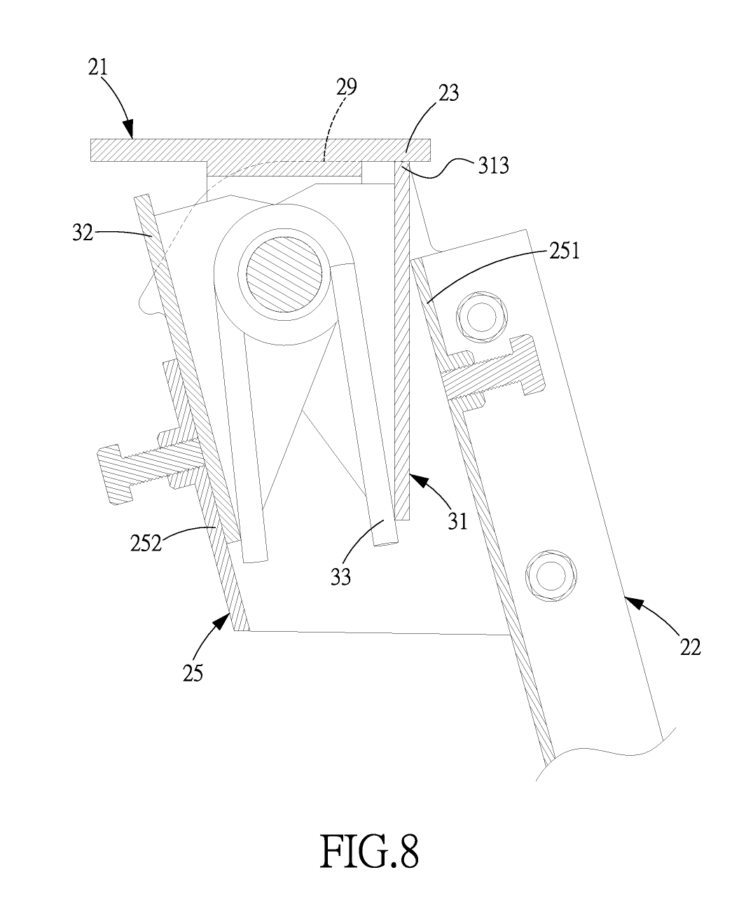

Referring then to FIGS. 8 and 5, when the side-skirt connecting member 22 pivots reversely about the mounting seat 21 and away from the large-scale vehicle, the second restricting member 32 will be pushed toward the first restricting member 31 by the inner end surface 252, while the first restricting member 31 stays stationary and is separated from the outer end surface 251 since it is stopped against the first positioning ribs 313. The third contact portions 29 of the pivot portion 25 will be abutted against the bottom of the top plate 23. At this moment, the elastic member 33 will be compressed since the distance between the first and second restricting members 31, 32 is reduced. Furthermore, the maximum angle that the side-skirt connecting member 22 is allowed to pivot away from the large-scale vehicle is equal to the second angle β.

In whichever direction the side-skirt connecting member 22 pivots (toward the bottom of the large-scale vehicle or in a reverse direction) when pivoting back to its original position, the pivoting motion of the side-skirt connecting member 22 will be buffered and slowed down by the elastic member 33, allowing the side-skirt connecting member 22 to pivot in a bidirectional manner, and preventing collision between the mounting seat 21 and the side-skirt connecting member 22.

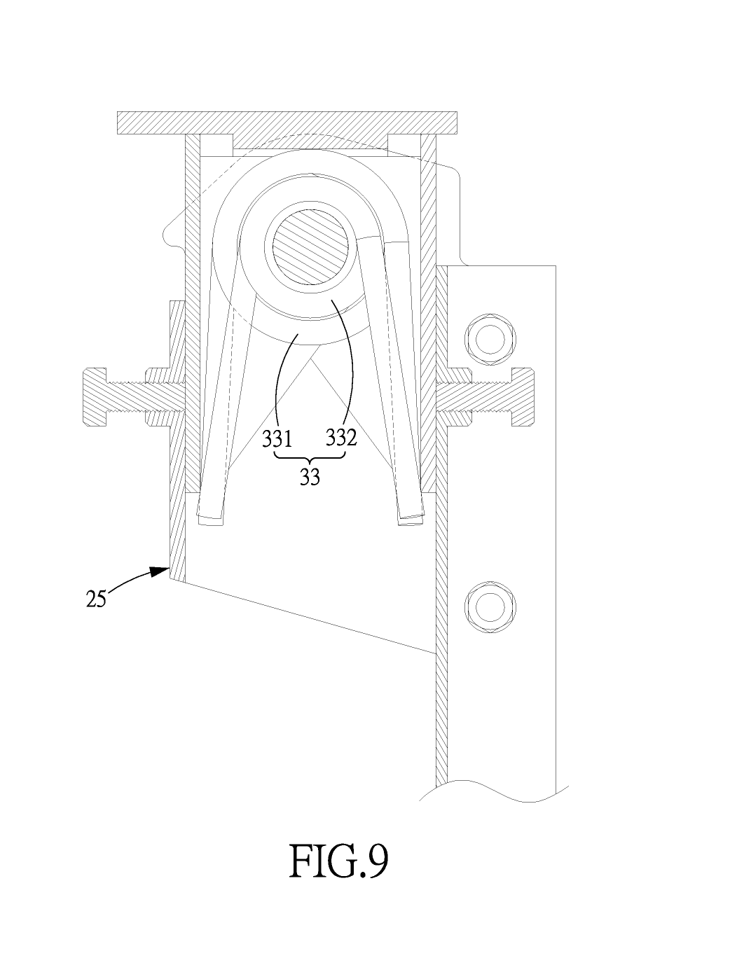

Referring then to FIG. 9, which shows another embodiment of the present invention, wherein the elastic member 33 includes a first torsion spring 331 and a second torsion spring 332, and the first torsion spring 331 is larger than the second torsion spring 332, so that the space inside the pivot portion 25 is effectively used.

While we have shown and described various embodiments in accordance with the present invention, it is clear to those skilled in the art that further embodiments may be made without departing from the scope of the present invention.

What is claimed is:

1. A load bearing structure for a large-scale vehicle comprising:
a base with a mounting seat and a side-skirt connecting member, the side-skirt connecting member having a pivot portion pivoted to the mounting seat, the pivot portion including a first contact portion, a second contact portion and a third contact portion, and under normal conditions, the first contact portion is abutted against the mounting seat; and
a return unit located within the pivot portion and pivoted to the mounting seat to keep the side-skirt connecting member staying in the normal conditions.

2. The load bearing structure for the large-scale vehicle as claimed in claim 1, wherein the pivot portion includes an outer end surface and an inn end surface, the return unit includes an elastic member, a first restricting member, and a second restricting member, the first restricting member has a first abutting surface abutted against the outer end surface of the pivot portion, and the second restricting member has a second abutting surface abutted against the inner end surface of the pivot portion, the first abutting surface is formed with a first positioning rib to push against the mounting seat, and the second abutting surface is also formed with a second positioning rib to push against the mounting seat, and the elastic member is disposed between the first and second restricting members.

3. The load bearing structure for the large-scale vehicle as claimed in claim 2, wherein the mounting seat is formed by a top plate and a connecting portion formed on a bottom of the top plate, each of the first and second restricting members has two wings, the first and second positioning ribs are pushed against the bottom of the top plate.

4. The load bearing structure for the large-scale vehicle as claimed in claim 2, wherein the elastic member is a torsion spring biased between the first and second restricting members.

5. The load bearing structure for the large-scale vehicle as claimed in claim 1, wherein the second contact portion defines a first angle ranging from 30-50 degrees with respect to the top plate of the mounting seat, and the third contact portion defines a second angle ranging from 10-20 degrees with respect to the top plate of the mounting seat.

6. The load bearing structure for the large-scale vehicle as claimed in claim 5, wherein the first angle is 40 degrees, and the second angle is 15 degrees.
